(19) United States
(12) Patent Application Publication
(10) Pub. No.: US 2011/0285619 A1
(43) Pub. Date: Nov. 24, 2011

(54) Method for identifying a sequence of input signals

(76) Inventors: Daniel Schifferdecker, Tuebingen (DE); Sergej Scheiermann, Eningen (DE)

(21) Appl. No.: 12/998,812

(22) PCT Filed: Oct. 30, 2009
(86) PCT No.: PCT/EP2009/064388

§ 371 Date: Aug. 9, 2011

(30) Foreign Application Priority Data
Dec. 16, 2008 (DE) 10 2008 054 732.8

(51) Int. Cl. G06F 3/01

(52) U.S. Cl. 345/156

(57) ABSTRACT

A method for identifying a sequence of input signals is proposed, a first input signal being identified in a first method step, a second input signal being identified within a predefined reference time in a second method step, and a time interval between the first input signal and the second input signal being determined in a third method step and furthermore the adapted reference time being set as a function of the time interval in a fourth method step.

### BACKGROUND INFORMATION

The present invention is directed to a method for identifying a sequence of input signals according to the definition of the species of Claim 1.

Such methods are generally known. For example, document DE 10 2004 001 226 A1 describes a method for identifying a double click, a first touch being detected using a key device in a first step, a second touch being detected using the key device in a second step, and a double-click signal being output in a third step if the sum of the durations of the first touch, the second touch, and the time interval between the first and second touches is less than a reference time. Thus, after the first touch, an identifying unit checks whether a second touch occurs within the reference time. In the case where no second touch occurs, the system waits for the entire reference time to elapse before a double-click signal may be ruled out. The disadvantage of this method is that the reference time is a fixed constant, so that when the user who typically double clicks via two clicks rapidly following each other performs a simple click, the system must wait for the relatively long reference time before outputting the single-click signal. No adaption of the reference time to the user behavior is provided.

### SUMMARY OF THE INVENTION

The method according to the present invention according to Claim 1 has the advantage over the related art that the reference time is set automatically as a function of the time characteristic of the input signals and thus, on the one hand, a considerably faster response time and, on the other hand, an adaption of the input signal evaluation to the individual usage behavior of an input signal producer, for example a human user or a sensor controlled by the human user, is achieved. This is achieved by determining the response time for future consecutive input signals which “belong together” as a function of the time interval between the first input signal and the second input signal, so that a predefined response time must be assumed only between the first two input signals, which is adapted as early as in the following step to the time characteristic of the input signals. Thus, in the case of a user who, for example, performs double clicks relatively slowly, a longer response time is automatically set, while in the case of a user who performs the exemplary double clicks more rapidly, a correspondingly shorter response time is set. This is advantageous in particular if a distinction not only between a single input signal and a double input signal is to be achieved, but also when greater input signal sequences such as triple input signals, quadruple input signals, quintuple input signal, etc., are to be identified. In the case of N-fold input signals, the adaption of the response time after the second input signal is adapted for all subsequent further (N−2) input signals. In this case, the method according to the present invention also allows a considerable reduction of the response time to be achieved, since the time savings is equal to the product of the difference between the predefined response time and the adapted response time and the factor (N−2). Because the time until the arrival of the next input signal is “anticipated” by the method, it is also possible to filter out false input signals and thus to increase the accuracy of the identification of input signals. This is achieved in that, on the one hand, the adapted reference value is set equal to the time interval and, on the other hand, a tolerance range is set around the reference value in which the further input signal must arrive in order to be identified. As defined by the present invention, setting the reference time as a function of the time interval includes, in particular, that the reference time is equal to the sum of the value of the time interval and a tolerance value. The tolerance value includes in particular a constant and increases the adapted reference value by a relatively small amount; thus small differences in the time characteristic of the input signal are also detected.

Advantageous embodiments and refinements of the present invention are derived from the subclaims and the description, with reference to the drawings.

According to one preferred refinement, it is provided that in the first method step and in the second method step an input signal counter is incremented by one, so that in a particularly advantageous manner the number of identified input signals is counted and/or stored for later output; in the case of N-fold input signals, the value of the input signal counter includes, in particular, the number N.

According to one further preferred refinement it is provided that in a fifth method step the system waits for another input signal for the duration of the reference time, so that it may be checked whether the double input signal is changed into a triple input signal or an N-fold input signal is changed into an (N+1)-fold input signal within the adapted reference time.

According to another preferred refinement it is provided that in a sixth method step the input signal counter is incremented by one if in the fifth method step another input signal is identified within the reference time, in which case the fifth method step is subsequently performed again. In particular, the further input signal is thus advantageously registered in the input signal counter and in the fifth method step the system again waits for the reference. In particular, the input signal counter is set to N when the Nth input signal is registered and then in the fifth method step the system waits for the identification of the (N+1)th input signal for the duration of the reference time. It is provided, in a particularly advantageous manner, that after the sixth and before the fifth method step, the third and fourth method steps are performed, the time reference being reset as a function of the time interval between the Nth input signal and the (N+1)th input signal in each case. The fifth and sixth method steps are performed consecutively as long as, in a fifth method step, the reference time has elapsed without a further input signal having been identified. In this case, a seventh method step is performed after the fifth method step.

According to another preferred refinement, it is provided that in a seventh method step an output signal is generated as a function of the input signal counter if in the fifth method step no further input signal is identified within the reference time. Thus, in a particularly advantageous manner, an output signal is output immediately after the reference time has elapsed, the output signal being preferably generated as a function of the number of identified input signals or of the input signal counter, or of the number N and is particularly preferably provided for controlling an electrical, electronic, and/or mechanical device, the device being, in particular, a microcontroller, a computer, a (cell) phone, a game pad, an electronic vehicle system, a handheld PC, an MP3 player, a navigation device, a mobile image and/or sound recorder, a mobile image and/or sound player, and/or a musical instrument. It is preferred in particular that the adapted response time is saved in connection with a user profile of the user and, when the user profile is loaded, replaces the predefined reference time. In a particularly preferred manner, the output signal includes both the value N of the input signal counter and the reference time.

According to one further preferred refinement, it is provided that when a further input signal is identified after the seventh method step, the input signal counter is reset and the first method step is performed again or, if a further input signal is identified after the seventh method step, the input signal counter is reset and the fifth method step is performed again. In a particularly preferred manner, the method according to the present invention is either restarted or the once adapted reference time is used for the subsequent double or multiple input signals. In one specific embodiment, the adapted reference time is cleared again, so that in the subsequent sequences of input signals the predefined reference time is initially used and a new adapted reference time is ascertained each time. Alternatively, the once adapted reference time is used for the subsequent sequences of input signals, the predefined reference time being preferably permanently replaced by the adapted reference time.

According to another preferred refinement, it is provided that in the third method step the time interval is compared with the reference time, so that in particular relatively large and thus occasionally erroneous deviations from the time interval and the reference time are discarded without adapting the reference time. Alternatively, an adaption of the reference time is performed only when the time interval is shorter than the reference time.

According to another preferred refinement, it is provided that the identification of an input signal is performed only when the signal amplitude of the input signal exceeds a signal threshold value and/or only when the signal length of the input signal exceeds a time threshold value. In a particularly advantageous manner, the input signal thus must have a certain signal height and/or a certain signal width for the identification of the input signal, so that the risk of misidentification due to false signals, for example due to external interference such as interfering radiation, vibrations, etc., is reduced.

According to another preferred refinement, it is provided that, after the identification of an input signal, the system waits for a down time before a subsequent input signal is identifiable. Typically the input signals perform a relatively short post-pulse oscillation, so that there is the risk that such a post-pulse oscillation exceeds the signal threshold value and is identified as another input signal. By waiting for the down time during which the post-pulse oscillations decay without identification, the risk of misidentification due to post-pulse oscillations is advantageously reduced.

According to one further preferred refinement, it is provided that the input signals are generated as a function of sensor signals, the sensor signals being generated in particular by an inertial sensor, a yaw rate sensor, a pressure sensor, a light sensor, a temperature sensor and/or a sound sensor, so that the control of a device with the aid of the sensor signals is advantageously enabled. Sensors of this type are in particular advantageously built into an input device, such as, for example, a computer mouse, a touch pad, a joystick, a laser pointer, and/or a track ball, and/or into a computer, a (cell) phone, a game pad, an electronic vehicle system, a handheld PC, an MP3 player, a navigation device, a mobile image and/or sound recorder, a mobile image and/or sound player, and/or a musical instrument.

Exemplary embodiments of the present invention are illustrated in the drawings and explained in greater detail in the description that follows.

### BRIEF DESCRIPTION OF THE DRAWINGS

FIG. 1 shows a schematic view of a method according to a first specific embodiment of the present invention;

FIG. 2 shows a schematic view of a method according to a second specific embodiment of the present invention, and

FIG. 3 shows a schematic block diagram of a method according to the first specific embodiment of the present invention.

### DETAILED DESCRIPTION OF THE INVENTION

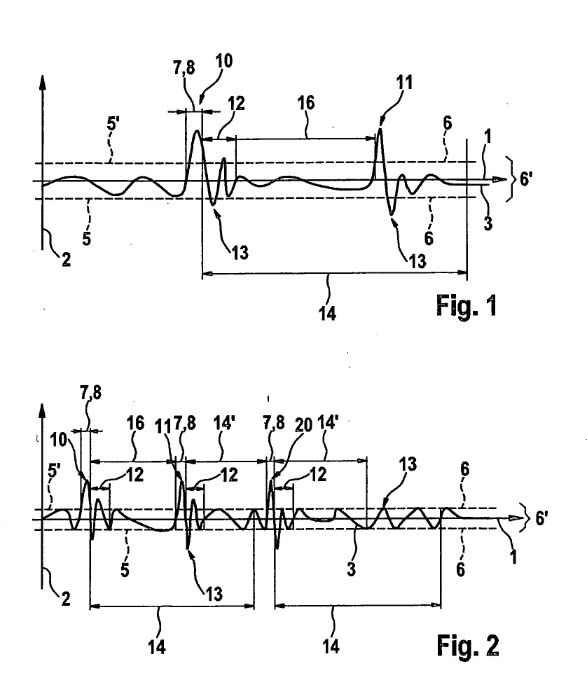

FIG. 1 shows a schematic view of a method according to a first specific embodiment of the present invention, a diagram having an abscissa 1 and an ordinate 2 being shown in FIG. 1; time is plotted on abscissa 1 and the amplitude is plotted on ordinate 2. Furthermore, in the diagram the amplitude of a signal 3 is plotted against time, signal 3 including, for example, an acceleration signal of an acceleration sensor (not illustrated), the acceleration signal including in particular the variation of an acceleration as a function of time. In the diagram, a signal threshold value 6, which has a constant value and defines a subthreshold range 6′ around abscissa 1, is shown in the form of two dashed lines 5, 5′. Signal 3 is identified only when the absolute value of signal 3 at a certain point in time is greater than the absolute value of signal threshold value 6 and consequently signal 3 is outside subthreshold range 6′. In addition, signal 3 must be outside subthreshold range 6′ for a certain period of time. In other words: For identifying signal 3, signal length 8 must be greater than a time threshold value 7 when signal threshold value 6 is exceeded. When signal 3 exceeds signal threshold value 6 and time threshold value 7, signal 3 is detected as first input signal 10 and an input signal counter (not illustrated) is set to one. At the same time, a time counter (not illustrated) is started. After a first input signal 10 has been identified, the system waits for a certain down time 12 before another input signal 11 is detectable. During this down time 12, undesirable post-pulse oscillations 13, which occur only due to the previous input signal 10 and yet exceed signal threshold value 6, are not identified. The system waits for a second input signal 11 at most for a predefined reference time 14. If the predefined reference time 14 elapses without a second input signal 11 being identified, an output signal with value 1 is generated corresponding to the value of the input signal counter, the time counter and the input signal counter are subsequently reset to zero and the method is restarted. However, in FIG. 1 a second input signal 11 is identified at a certain point in time within the predefined reference value 14, and time interval 16 between first input signal 10 and second input signal 11 is measured with the aid of the time counter. After second input signal 11 has been identified, the predefined reference time 14 is replaced with the value of the ascertained time interval 16 plus a tolerance value, the tolerance value including a constant, so that the adapted reference time 14′ is slightly increased by the tolerance value and thus a tolerance range is generated around the measured time interval. In a following cycle, the system waits for a subsequent further input signal only for the adapted reference time 14′, which is much shorter than the predefined reference time 14. If no further input signal is identified in this cycle within the adapted reference time 14′, an output signal with value 2 is output, the input signal counter and the time counter are reset, and the method is restarted. Adapted reference value 14′ is now alternatively further used as a new predefined reference value or replaced with the initially predefined reference value 14.

FIG. 2 shows a schematic view of a method according to a second specific embodiment of the present invention, a first, a second, and a third input signal 10, 11, 20 being identified, the system waiting for the further input signal after the second and third input signal 11, 20 only for the duration of the adapted reference value.

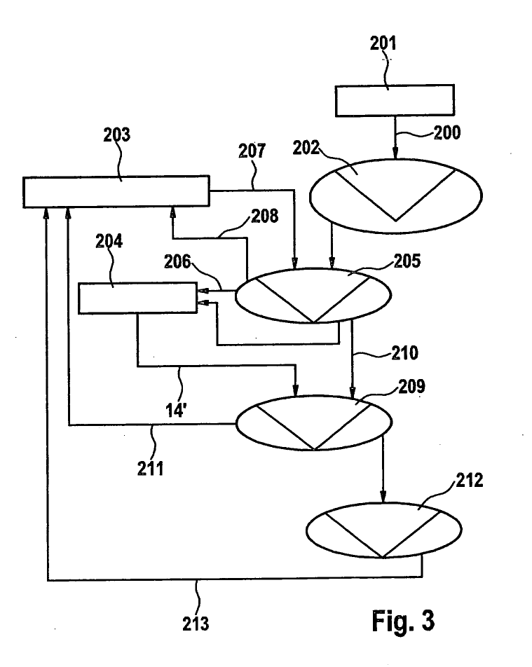

FIG. 3 shows a schematic block diagram of a method according to the first specific embodiment of the present invention, an acceleration signal 200 being initially output by an acceleration sensor 201, a check being performed in a first block 202 whether acceleration signal 200 is greater than signal threshold value 6, and in the case that acceleration signal 200 is greater, the instantaneous value of input signal counter 203 is queried 207 in a second block 205. If the value of input signal counter 203 is smaller than or equal to one, acceleration signal 200 is identified as first input signal 10, the value of input signal counter 203 is incremented 208 by one, and a time counter 204 is started 206. However, if the value of input signal counter 203 is greater than one, input signal 200 is identified as second or further input signal 11, 20 and time counter 204 is stopped, the value of time counter 204 being used as adapted reference value 14′. Subsequently, second or further input signal 11, 20 is supplied 210 to a third block 209. In second block 209 a check is performed whether second or further input signal 11, 20 was identified within adapted reference time 14′ (for second input signal 20 this is inevitably the case), input signal counter 203 being incremented 211 by one in this case. Otherwise a check is performed in fourth block 212 whether further input signal 20 was registered within down time 12. If further input signal 20 was registered outside down time 12, the method is terminated or restarted and input counter 203 is reset 213. Signal threshold value 6 and time threshold value 7 are established in particular as a function of the particular application.

What is claimed is:

1. A method for identifying a sequence of input signals (10, 11, 20), a first input signal (10) being identified in a first method step, a second input signal (11) being identified within a predefined reference time (14) in a second method step, and a time interval (16) between the first input signal (10) and the second input signal (11) being determined in a third method step,
wherein an adapted reference time (14′) is set as a function of the time interval (16) in a fourth method step.

2. The method as recited in claim 1,
wherein an input signal counter (203) is incremented by one in the first method step and in the second method step.

3. The method as recited in the preceding claims,
wherein the system waits for a further input signal (20) for the duration of the adapted reference time (14′) in a fifth method step.

4. The method as recited in the preceding claims,
wherein the input signal counter (203) is incremented by one in a sixth method step if a further input signal (20) is identified within the adapted reference time (14′) in the fifth method step, the fifth method step being subsequently performed again.

5. The method as recited in one of the preceding claims, wherein an output signal is generated as a function of the input signal counter (203) in a seventh method step if no further input signal (20) is identified within the adapted reference time (14′) in the fifth method step.

6. The method as recited in one of the preceding claims, wherein, if a further input signal (20) is identified after the seventh method step, the input signal counter (203) is reset and the first method step is performed again or, if a further input signal (20) is identified after the seventh method step, the input signal counter (203) is reset and the fifth method step is performed again.

7. The method as recited in one of the preceding claims, wherein the time interval (16) is compared with the reference time (14) in the third method step.

8. The method as recited in one of the preceding claims, wherein an input signal (10, 11, 20) is identified only if the signal amplitude (3) of the input signal (10, 11, 20) exceeds a signal threshold value (6) and/or only if the signal length (8) of the input signal (10, 11, 20) exceeds a time threshold value (7).

9. The method as recited in one of the preceding claims, wherein after an input signal (10, 11, 20) has been identified, the system waits for a down time (12) before a subsequent input signal (11, 20) is identifiable.

10. The method as recited in one of the preceding claims, wherein the input signals (10, 11, 20) are generated as a function of sensor signals (200), the sensor signals (200) being generated by an inertial sensor (201), a yaw rate sensor, a pressure sensor, a light sensor, a temperature sensor, and/or a sound sensor in particular.
